(19) United States
(12) Patent Application Publication
(10) Pub. No.: US 2025/0265508 A1
(43) Pub. Date: Aug. 21, 2025

(54) CLASSIFIER TRAINING DEVICE AND METHOD

(71) Applicant: ELECTRONICS AND TELECOMMUNICATIONS RESEARCH INSTITUTE, Daejeon (KR)

(72) Inventors: Jung Hoon LEE, Daejeon (KR); Cheol Ho KIM, Daejeon (KR)

(21) Appl. No.: 19/024,652

(22) Filed: Jan. 16, 2025

(30) Foreign Application Priority Data
Feb. 16, 2024 (KR) 10-2024-0022697

(51) Int. Cl. G06N 20/20; G06F 18/241

(52) U.S. Cl. CPC G06N 20/20; G06F 18/241

(57) ABSTRACT

Provided are a classifier training device and method. The classifier training device incrementally trains a classifier in varying feature spaces (VFS) and includes a memory configured to store at least one instruction and a processor configured to execute the at least one instruction stored in the memory. When input data is received, the processor updates at least one of existing base models constituting an ensemble model on the basis of the input data, generates at least one new base model on the basis of the input data, and adds the at least one new base model to the ensemble model.

### CROSS-REFERENCE TO RELATED APPLICATION

This application claims priority to and the benefit of Korean Patent Application No. 10-2024-0022697, filed on Feb. 16, 2024, the disclosure of which is incorporated herein by reference in its entirety.

### BACKGROUND

### 1. Field of the Invention

The present invention relates to a classifier training device and method for incrementally training a classifier in varying feature spaces (VFS).

### 2. Description of Related Art

When training on data that has already been collected, it is easier to train a classifier on the basis of entire data. However, when data is continuously added over time, it is necessary to train the classifier every time data is added, which is very inefficient. Also, it is not easy in practice to gather personal information-related data in one place for training. Incremental learning (IL) is a training method for solving this problem and aims to learn multiple temporally and spatially separated data sets sequentially and separately while achieving performance comparable to learning the entire data.

When data is temporally separated and given as a stream or spatially separated and divided into multiple datasets, variable spaces (variable configurations) that constitute each piece of the separated data may differ, and in this case, the data is referred to as having variable feature spaces (VFS). There are various forms of VFS, which may be regular or irregular, and the differences between neighboring data spaces may be small or large.

Since models are used in a variety of situations through various clients in the real world, it is very important to enhance the practicality of a model that the model is universally robust over variable spaces that may be defined in various ways. However, when a model incrementally learns more variable spaces, the number of variable spaces that are not directly learned but may be derived indirectly significantly increases, and there are limitations to using individual models to handle the variable spaces. Therefore, a method of training a classifier that can operate in various variable spaces by enhancing universality and robustness of the classifier is necessary.

### SUMMARY OF THE INVENTION

The present invention is directed to providing a classifier training device and method for incrementally training a classifier in varying feature spaces (VFS).

According to an aspect of the present invention, there is provided a classifier training device including a memory configured to store at least one instruction and a processor configured to execute the at least one instruction stored in the memory. When input data is received, the processor updates at least one of existing base models constituting an ensemble model on the basis of the input data, generates at least one new base model on the basis of the input data, and adds the at least one new base model to the ensemble model.

The ensemble model may be an averaged n-dependence estimator (AnDE).

The processor may select at least one of the existing base models as a target base model on the basis of the input data and update the target base model on the basis of the input data.

The processor may select, as the target base model, a base model of which all variables corresponding to parent nodes are included in a variable space of the input data.

The processor may update a possibility table corresponding to variables included in the variable space of the input data among all variables corresponding to the parent nodes and child nodes of the target base model.

The processor may generate a candidate variable set on the basis of the input data and generate the new base model on the basis of variables included in the candidate variable set.

The processor may identify variables that are not included in a variable space of the ensemble model among variables included in a variable space of the input data and include the identified variables in the candidate variable set.

The processor may calculate distance values from each of variables included in a variable space of the input data to each of variables included in a variable space of the ensemble model, select n of the variables included in the variable space of the input data on the basis of the calculated distance values, and include the n selected variables in the candidate variable set.

The processor may calculate frequencies of each of variables included in a variable space of the input data being used as a parent node in a variable space of the ensemble model, identify n variables in increasing order of the calculated frequencies, and include the n identified variables in the candidate variable set.

The processor may generate, as the new base model, a base model that has at least one of the variables included in the candidate variable set as a parent node and has the variables in the variable space of the input data other than the variable selected as the parent node as child nodes.

The processor may calculate evaluation indices for each of base models constituting the ensemble model, and the evaluation indices may be used in a pruning process of the base models constituting the ensemble model.

The processor may perform a process of calculating an accumulated classification accuracy index, calculating an expected evaluation index, and adding the accumulated classification accuracy index and the expected evaluation index to which a preset weight is applied, for a base model to calculate an evaluation index for the base model.

The processor may perform a process of classifying instances included in the input data and storing classification results for each of the base models constituting the ensemble model every time input data is received, and perform a process of analyzing cumulatively stored classification results for the base model to calculate an accumulated classification accuracy index for the base model.

The processor may perform a process of calculating uniqueness indices of each of variables included in a variable space and calculating an average of the calculated uniqueness indices for the base model to calculate an expected evaluation index for the base model.

The processor may calculate distance values from each of the variables included in the variable space to each of the variables included in the variable space other than the variable, calculate a sum of the calculated distance values, and divide the calculated sum by (a total number of variables included in the variable space-1) to calculate a uniqueness index of any variable included in any variable space.

The processor may calculate information about a parent node of each base model, a generation method for the parent node, the number of all instances included in all input data used for training, and an elapsed time after generation.

According to another aspect of the present invention, there is provided a classifier training method including, when input data is received, updating at least one of existing base models constituting an ensemble model on the basis of the input data, generating at least one new base model on the basis of the input data, and adding the at least one new base model to the ensemble model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a classifier training device according to an exemplary embodiment of the present invention;

FIG. 2 is a block diagram of a processor of a classifier training device according to an exemplary embodiment of the present invention;

FIG. 3 is an example diagram illustrating a base model selection module according to an exemplary embodiment of the present invention;

FIG. 4 is an example diagram illustrating a base model update module according to an exemplary embodiment of the present invention;

FIG. 5 is an example diagram schematically illustrating a process of generating a candidate variable set according to an exemplary embodiment of the present invention;

FIG. 6 is an example diagram illustrating a base model generation module according to an exemplary embodiment of the present invention; and

FIGS. 7 and 8 are flowcharts illustrating a method of training a classifier according to an exemplary embodiment of the present invention.

### DETAILED DESCRIPTION OF EXEMPLARY EMBODIMENTS

Hereinafter, a device and method for training a classifier according to exemplary embodiments of the present invention will be described in detail with reference to the accompanying drawings. In this process, the thicknesses of lines, the sizes of components, and the like shown in the drawings may be exaggerated for the purpose of clarity and convenience of description. Also, terms used herein are defined in consideration of functions in the present invention, and the terms may vary depending on the intention of a user or operator or precedents. Therefore, these terms are to be defined on the basis of the overall content of the specification.

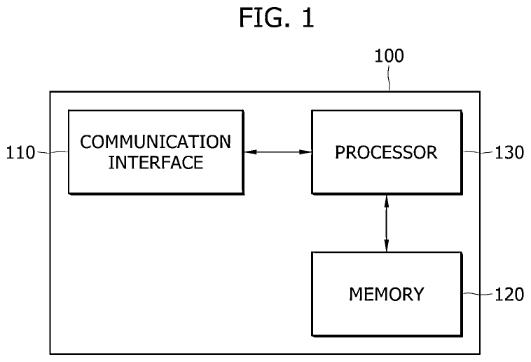

FIG. 1 is a block diagram of a classifier training device according to an exemplary embodiment of the present invention.

Referring to FIG. 1, a device 100 for training a classifier according to an exemplary embodiment of the present invention may include a communication interface 110, a memory 120, and a processor 130. The device 100 for training a classifier according to an exemplary embodiment of the present invention may further include various components in addition to the components shown in FIG. 1, or some of the components may be omitted.

The device 100 for training a classifier according to an exemplary embodiment of the present invention may be intended to train a classifier based on an ensemble model (or an ensemble pool). The device 100 for training a classifier according to an exemplary embodiment of the present invention may perform incremental training using datasets D₁, . . . , and D_{N} having different variable spaces S₁, . . . , and S_{N}. The device 100 for training a classifier according to an exemplary embodiment of the present invention may be a device for training an averaged n-dependence estimator (AnDE)-based classifier. An AnDE is a Bayesian network classifier, which is an ensemble model composed of a plurality of base models. Each base model in the AnDE may be a naïve bayes model to which rule-based structure expansion is applied. Since this base model expands on the basis of rules, processing of a missing value, addition of a variable, and the like are easy compared to that in not only a structure learning-based Bayesian network classifier but also other machine learning algorithms such as random forest, a support vector machine, and the like.

The base models are expanded naïve bayes models and may have (n+1) parent nodes corresponding to a total of (n+1) variables including a class variable and child nodes corresponding to variables other than the variables corresponding to the parent nodes. A mathematical representation of how a base model factorizes a probability distribution over all variables may be given by Equation 1 below. Here, C may be a class variable, Xᵢ^{P} may be a parent node (variable), Xⱼ^{C} may be a child node (variable), and m may be the number of all variables other than the learned class variable.

$$P ( {X}_{1}^{P} , … , {X}_{n}^{P} , {X}_{1}^{C} , … , {X}_{m - n}^{C} , C ) = P ( {X}_{1}^{P} \vert C ) P ( {X}_{2}^{P} \vert {X}_{1}^{P} , C ) … P ( {X}_{n}^{P} \vert {X}_{1}^{P} , … {X}_{n - 1}^{P} , C ) \times P ( {X}_{1}^{C} \vert {X}_{1}^{P} , … {X}_{n}^{P} , C ) … P ( {X}_{m - n}^{C} \vert {X}_{1}^{P} , … {X}_{n}^{P} , C ) \times P ( C ) \qquad [ Equation 1 ]$$

The communication interface 110 may communicate with an external device. The communication interface 110 may communicate with various kinds of external devices in accordance with various kinds of communication methods. For example, the communication interface 110 may communicate with an external device to receive input data transmitted from the external device. The input data may be a dataset, which may include various variables. A space composed of the variables included in the input data may be defined as a variable space of the input data.

The memory 120 may store at least one instruction executed by the processor 130. The memory 120 may be implemented as a volatile storage medium and/or non-volatile storage medium. For example, the memory 120 may be implemented as a read-only memory (ROM) and/or a random access memory (RAM).

The memory 120 may store various kinds of information required for operating processes of the processor 130. The memory 120 may store various kinds of information calculated in the operating processes of the processor 130.

The processor 130 may be implemented as a central processing unit (CPU) or a system on chip (SoC) and may run an operating system (OS) or application to control a plurality of hardware components connected to the processor 130 or a plurality of software components and perform various kinds of data processing and computations. The processor 130 may be configured to execute the at least one instruction stored in the memory 120 and store the execution result data in the memory 120.

When input data is received, the processor 130 may update at least one of the existing base models constituting the ensemble model on the basis of the input data, generate at least one new base model on the basis of the input data, and add the generated one new base model to the ensemble model. According to the present embodiment, it is possible to not only update the existing base models constituting the ensemble model using the input data but also generate a new base model in consideration of the variable space of the input data and add the generated base model to the ensemble model. A classifier obtained through the foregoing process can ensure excellent performance for not only variable spaces that have directly learned but also any partial variable space (any subset) of the entire variable space of the ensemble model.

The processor 130 may calculate evaluation indices for each of the base models constituting the ensemble model. An evaluation index is a value obtained by quantifying the performance and importance of a base model and may be used in a pruning process of the base models constituting the ensemble model. With the progress of an incremental learning process, the ensemble model may increase in size (the number of base models constituting the ensemble model). Since resources available to the classifier are limited, it is necessary to limit the size of the ensemble model. To perform incremental learning with a limit on the size of the ensemble model, it is necessary to perform pruning. According to the present embodiment, pruning of the ensemble model can be performed more effectively by identifying a base model with the lowest evaluation index among the base models constituting the ensemble model and excluding the identified base model from the ensemble model. The evaluation indices may also be used in a process of combining the base models for inference.

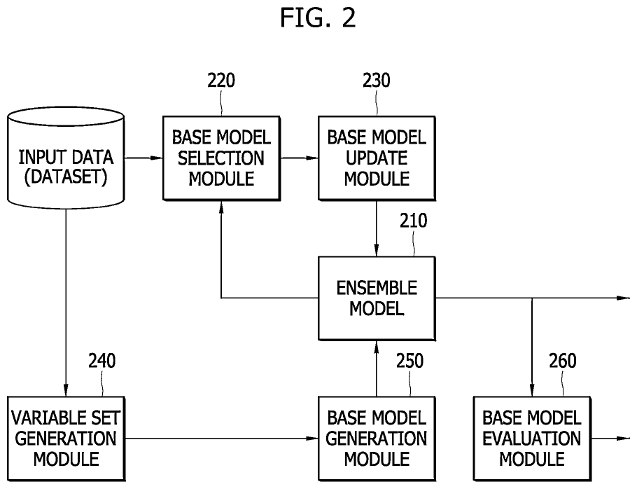

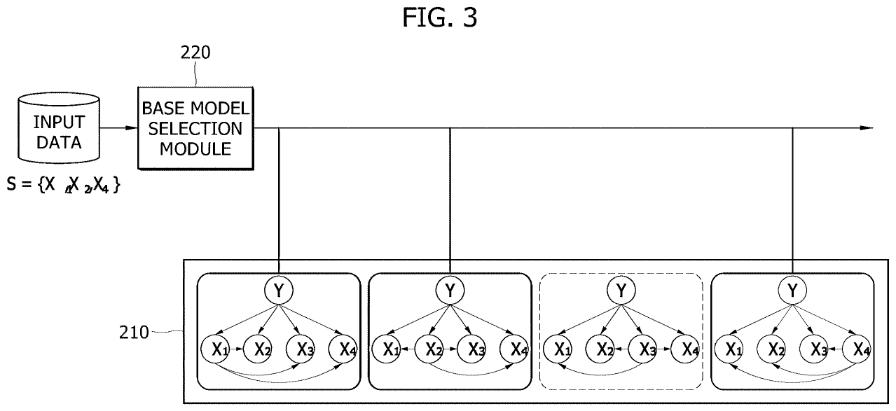

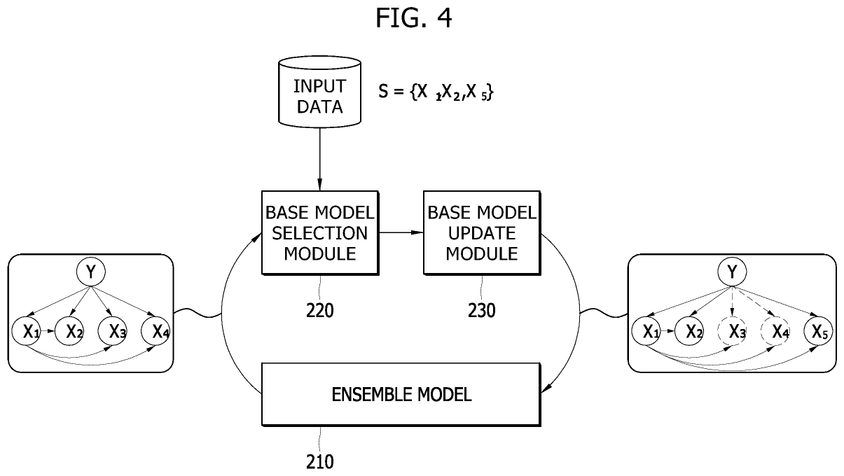

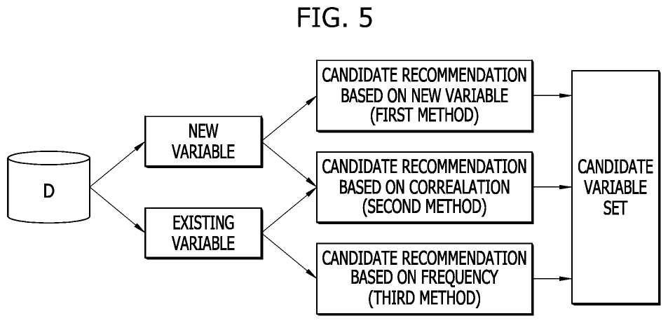

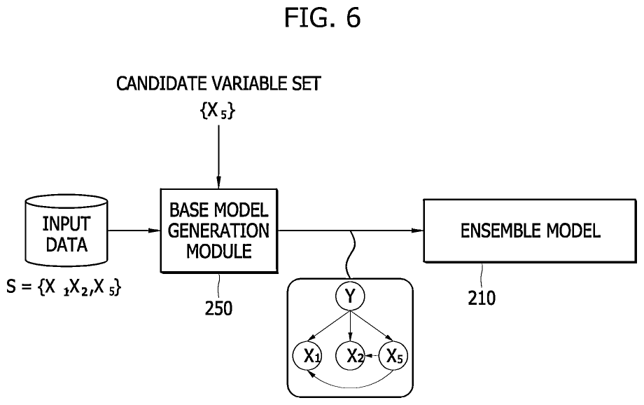

FIG. 2 is a block diagram of a processor of a classifier training device according to an exemplary embodiment of the present invention, FIG. 3 is an example diagram illustrating a base model selection module according to an exemplary embodiment of the present invention, FIG. 4 is an example diagram illustrating a base model update module according to an exemplary embodiment of the present invention, FIG. 5 is an example diagram schematically illustrating a process of generating a candidate variable set according to an exemplary embodiment of the present invention, and FIG. 6 is an example diagram illustrating a base model generation module according to an exemplary embodiment of the present invention.

Referring to FIG. 2, the processor 130 of the device 100 for training a classifier according to an exemplary embodiment of the present invention may include an ensemble model 210, a base model selection module 220, a base model update module 230, a variable set generation module 240, a base model generation module 250, and a base model evaluation module 260. The modules illustrated in the present embodiment are components that take charge of some operations of the processor 130 classified by function, and operations performed by each of the modules may be understood as operations performed by the processor 130.

When input data is received, the base model selection module 220 may select a base model to be updated (hereinafter, “target base model”) from among existing base models constituting the ensemble model 210 on the basis of the input data. As the target base model, the base model selection module 220 may select a base model of which all variables corresponding to parent nodes are included in a variable space of the input data. In other words, the base model selection module 220 may identify a base module of which at least one of all the variables corresponding to the parent nodes is not included in the variable space of the input data, and select the base modules other than the identified base model as target base models. There may be one or more target base models, and in some cases, no target base model may exist.

For example, as shown in FIG. 3, it is assumed that variables included in a variable space S of input data are {X₁, X₂, X₄} and the ensemble model 210 is composed of a first base model (the first one from the left) of which a parent variable (a variable corresponding to a parent node) is X₁, a second base model (the second one from the left) of which a parent variable is X₂, a third base model (the third one from the left) of which a parent variable is X₃, and a fourth base model (the fourth one from the left) of which a parent variable is X₄. Since a variable X₃ is not included in the variable space of the input data, the third base model having the variable X₃ as a parent variable may be excluded from target base models.

Meanwhile, even when only some parent variables are included in the variable space of the input data, the corresponding base model may be selected as a target base model and updated. However, the total number of variables learned by base models is generally much larger than the number of parent nodes, it is preferable to exclude base models of which only some parent variables are included in the variable space of the input data from target base models for algorithmic parallelization and the like.

The base model update module 230 may update target base models on the basis of the input data. The base model update module 230 may update the target base models by updating probability tables of the target base models on the basis of the input data. The base model update module 230 may generate probability tables (conditional probability tables for individual nodes) on the basis of new input data and existing input data and update existing probability tables using the generated probability tables.

For example, as shown in FIG. 4, when variables included in a variable space S of input data are {X₁, X₂, X₅}, the base model update module 230 may update base model that has a parent variable of X₁ and child nodes of X₂, X₃, and X₄. In this case, probability tables for the child variables X₁ and X₂ may be updated, probability tables for the child variables X₃ and X₄ may not be updated, and a probability table for the child variable X₅ may be newly generated.

When any base model is updated, the base model update module 230 may calculate and record the number of all instances (cases) included in all input data used for training the base model. In other words, when any base model is updated, the base model update module 230 may calculate a value by adding the number of instances included in new input data which is currently used for training to the number of instances included in existing input data which has been used for training the corresponding base model, and store the value. The base model update module 230 may periodically or aperiodically calculate a time that has elapsed since the generation of the base model, and may store the time.

The variable set generation module 240 may generate a candidate variable set on the basis of the input data. The candidate variable set is a set of at least one variable and may be used for generating a base model. The variable set generation module 240 may determine variables to be included in the candidate variable set using the following first, second, third methods. An operating process of the variable set generation module 240 may be the same as shown in FIG. 5.

The variable set generation module 240 may identify a variable that is not included in a variable space of the ensemble model 210 among variables included in the variable space of the input data, and may include the identified variable in the candidate variable set (first method). When the first method is used, the variable set generation module 240 may include n preset variables in the candidate variable set. When the number of identified variables exceeds n, the variable set generation module 240 may randomly select n variables on the basis of a uniform distribution. Meanwhile, when the number of previously identified variables is less than n, the variable set generation module 240 may randomly select the variables other than the n previously identified variables in the variable space of the input data to fill in the missing number of variables.

Here, the variable space of the ensemble model 210 may be a combined variable space of all variable spaces of each of the base models constituting the ensemble model 210. In other words, the variable space of the ensemble model 210 may be a variable space corresponding to the union of variables included in all input data used for learning. When the first method is used, the variable set generation module 240 may identify a variable that is not included in any of the base models constituting the ensemble model 210 among the variables included in the variable space of the input data and may include the identified variable in the candidate variable set.

The variable set generation module 240 may calculate distances from each of the variables included in the variable space of the input data to each of the variables included in the variable space of the ensemble model 210, select n of the variables included in the variable space of the input data on the basis of the calculated distance values, and include the n selected variables in the candidate variable set (second method).

The variable set generation module 240 may calculate correlations between different variables and calculate distances between the different variables on the basis of the calculated correlations. Although the variable set generation module 240 may utilize various indicators as correlation indicators, mutual information may be used as correlation indicators in the present embodiment. Since mutual information uses a probability table in a Bayesian network, mutual information can be calculated without consuming additional resources and incrementally learned with ease, and allows handling of various interdependencies, such as non-linearity, non-monotonicity, and the like. Mutual information between different variables Xᵢ and Yⱼ may be calculated by Equation 2 below.

$$I ( {X}_{i} ; {X}_{j} ) = {\sum }_{{x}_{i , k} ∈ V a l ( {X}_{i} )} {\sum }_{{x}_{j , l} ∈ Val ( {X}_{j} )} p ( {x}_{i , k} , {x}_{j , l} ) log ( \frac{p ( {x}_{i , k} , {x}_{j , l} )}{p ( {x}_{i , k} ) p ( {x}_{j , l} )} ) \qquad [ Equation 2 ]$$

The variable set generation module 240 may consider each row (or column) in a correlation matrix to be a position in m-dimensional space representing variables and calculate the distances between the different variables using Equation 3 below. In Equation 3 below, 1′ may be normalized mutual information. The variable set generation module 240 may repeatedly perform a process of calculating the square of a difference between mutual information between the variables Xᵢ and Xₖ and mutual information between the variables Xⱼ and Xₖ while changing the variable Xₖ, add the calculated squares together, and divide the sum by m (the total number of variables), calculating a distance between the variables Xᵢ and Xₖ

$$Dist ( {X}_{i} ; {X}_{j} ) = \frac{1}{m} \sum {( {I}^{′} ( {X}_{i} ; {X}_{k} ) - {I}^{′} ( {X}_{j} ; {X}_{k} ) )}^{2} \qquad [ Equation 3 ]$$

The variable set generation module 240 may perform a process of calculating uniqueness indices for each of the variables included in the variable space of the input data on the basis of distances between each of the variables included in the variable space of the input data and each of the variables included in the variable space of the ensemble model 210, select n variables on the basis of unique indices for each of the variables included in the variable space of the input data, and include the n selected variables in the candidate variable set. The uniqueness index of a variable may be calculated using Equation 4 below. The variable set generation module 240 may select n of the variables included in the variable space of the input data by sampling n of m variables on the basis of a probability distribution obtained by normalizing the uniqueness indices of each of the variables. Here, a variable with a higher uniqueness index may be sampled more frequently.

$$Unique ( {X}_{i} ) = \frac{1}{m - 1} \sum D i s t ( {X}_{i} ; {X}_{k} ) \qquad [ Equation 4 ]$$

The variable set generation module 240 may calculate frequencies of each of the variables included in the variable space of the input data being used as a parent node in the variable space of the ensemble model 210, identify n variables in increasing order of the calculated frequencies, and include the n identified variables in the candidate variable set (third method). In the case of continuously performing an operation of adding a new base model to the ensemble model 210 and an operation of excluding a base model with a low evaluation index from the ensemble model 210, a frequency of a specific variable being used as a parent node may be remarkably reduced compared to those of other variables. While this may be regarded as a natural culling of variables that contribute less to classification, caution is necessary in culling certain variables because variables used as parent nodes significantly less frequently than others may play an important role when other variables are subsequently added to the variable space of the ensemble model 210. The present embodiment mainly employs the first and second methods and auxiliarily employs the third method to prevent a specific variable from being completely culled.

The variable set generation module 240 may estimate the performance of each of the first to third methods and adjust the ratio of use of the first to third methods on the basis of the results of estimating the performance of each of the first to third methods. To improve the classification performance of the classifier, it is necessary to derive a candidate subset using an appropriate method for changes of a dataset and a variable space. Therefore, the variable set generation module 240 can further improve the classification performance of a classifier by increasing the ratio of use of a method with excellent performance among the first to third methods than the ratio of use of other methods. The variable set generation module 240 may estimate the performance of the first to third methods on the basis of information about base models and evaluation indices thereof to be described below.

The base model generation module 250 may generate at least one new base model on the basis of variables included in the candidate variable set. The base model generation module 250 may generate, as the new base model, a base model that has at least one of the variables included in the candidate variable set as a parent node and has the variables in the variable space of the input data other than the variable selected as the parent node as child nodes. The base model generation module 250 may repeatedly perform the process of generating a new base model while changing a variable selected as a parent node, generating a plurality of new base models.

For example, as shown in FIG. 6, when variables included in a variable space S of input data are {X₁, X₂, X₅} and a variable included in aa candidate variable set is X₅, the base model generation module 250 may generate a base model that has X₅ as a parent node and X₁ and X₂ as child nodes.

The base model generation module 250 may add the new base model to the ensemble model 210. When adding the new base model to the ensemble model 210, the base model generation module 250 may store information about a parent variable of the new base model and a parent variable generation method (which one of the first to third methods described above has been used for selecting the parent variable). The information about the parent variable of the base model and the parent variable generation method may be utilized in a pruning process of the base models constituting the ensemble model 210 together with information about the number of all instances included in all input data used for training the base model.

The base model evaluation module 260 may calculate evaluation indices for each of the base models constituting the ensemble model 210. The base model evaluation module 260 may perform a process of calculating an accumulated classification accuracy index, calculating an expected evaluation index, and adding the accumulated classification accuracy index and the expected evaluation index to which a preset weight is applied, for a base model to calculate an evaluation index for the base model. An evaluation index for a base model may be defined as shown in Equation 5 below. In Equation 5 below, SCORE_{base} may be an evaluation index, SCORE_{acc} may be an accumulated classification accuracy index, SCOREₑₓₚ may be an expected evaluation index, and λ may be a weight which is set to a value smaller than 1.

$${SCORE}_{b a s e} = {SCORE}_{a c c} + λ \cdot {SCORE}_{e x p} \qquad [ Equation 5 ]$$

When an evaluation index (weight) of a base model is calculated only using an accumulated classification accuracy index, overfitting on datasets that have been hitherto learned may occur. Therefore, according to the present embodiment, an evaluation index of a base model may be calculated using an accumulated classification accuracy index and an expected evaluation index together.

The base model evaluation module 260 may perform a process of classifying instances included in input data and storing the classification results for each of base models included in the ensemble model 210 every time input data is received. The base model evaluation module 260 may perform a process of analyzing (combining) cumulatively stored classification results for a base model and calculating an accumulated classification accuracy index for any base model to calculate an accumulated classification accuracy index for the base model. The accumulated classification accuracy index may be set to a value between 0 and 1. The base model evaluation module 260 may calculate a ratio of classification results corresponding to ground truth to classification results of all instances included in all input data used for training, calculating an accumulated classification accuracy index.

The base model evaluation module 260 may perform a process of calculating a uniqueness index of each of the variables included in the variable space and calculating an average of the uniqueness indices calculated for each of the variables for a base model to calculate an expected evaluation index for the base model. A uniqueness index may be calculated using Equation 4 above. The base model evaluation module 260 may calculate distance values from each of variables included in a variable space to each of the variables included in the variable space other than the variable, calculate a sum of the calculated distance values, and divide the calculated sum by (the total number of variables included in the variable space-1) to calculate a uniqueness index of any variable included in any variable space. An expected evaluation index may be determined to be an average of uniqueness indices of variables irrespective of how a parent variable of a corresponding base model has been selected. An expected evaluation index may be set to a value between 0 and 1.

Unlike the related art which deals with varying feature spaces (VFS) but only focuses on performance on a recent variable space or performance on some variable spaces, the present invention is universally robust to a wider range of variable spaces by expanding a structure on the basis of an ensemble and rules, selecting base models, and calculating base model evaluation indices while minimizing optimization factors. Such an advantage may be particularly useful in a situation with various classifiers and service environments of Internet of things (IoT), drones, robots, and the like, which are used through clients and thus it is difficult to predict the composition of data.

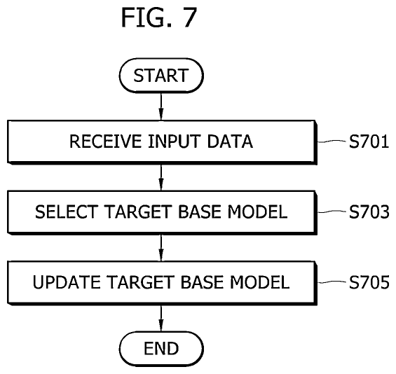

FIG. 7 is a first flowchart illustrating a method of training a classifier according to an exemplary embodiment of the present invention.

A process of updating a base model will be described below with reference to FIG. 7, focusing on operations of the processor 130. A part of the following process may be performed in a different order than that described below or may be omitted. Meanwhile, detailed description of elements that have been described above will be omitted, and a time-series configuration thereof will be mainly described.

First, the processor 130 may receive input data (S701). The processor 130 may receive externally transmitted input data through the communication interface 110.

Subsequently, the processor 130 may select a target base model to be updated from among existing base models constituting an ensemble model on the basis of the input data (S703). As the target base model, the processor 130 may select a base model of which all variables corresponding to parent nodes are included in a variable space of the input data.

Subsequently, the processor 130 may update the target base model on the basis of the input data (S705). The update of the target base model may be performed by updating a probability table corresponding to variables included in the variable space of the input data among all variables corresponding to the parent nodes and child nodes of the target base model.

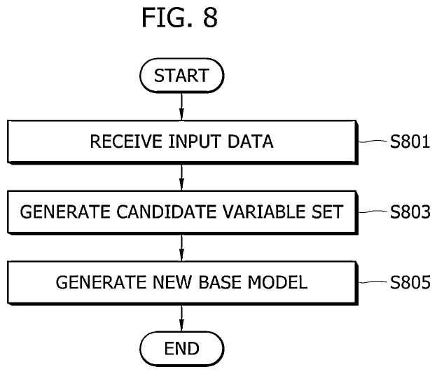

FIG. 8 is a second flowchart illustrating a method of training a classifier according to an exemplary embodiment of the present invention.

A process of generating a base model will be described below with reference to FIG. 8, focusing on operations of the processor 130. A part of the following process may be performed in a different order than that described below or may be omitted. Meanwhile, detailed description of elements that have been described above will be omitted, and a time-series configuration thereof will be mainly described.

First, the processor 130 may receive input data (S801). The processor 130 may receive externally transmitted input data through the communication interface 110.

Subsequently, the processor 130 may generate a candidate variable set on the basis of the input data (S803). The processor 130 may determine variables to be included in the candidate variable set using at least one of the first to third methods described above.

Subsequently, the processor 130 may generate at least one new base model on the basis of the candidate variable set (S805). As the new base model, the processor 130 may generate a base model that has at least one of the variables included in the candidate variable set as a parent node and has variables in a variable space of the input data other than the variable selected as the parent node as child nodes.

As described above, with the device and method for training a classifier according to exemplary embodiments of the present invention, a classifier can be incrementally trained in VFS, and classification can be performed in various variable spaces that are learned directly or indirectly by the classifier trained through incremental learning.

According to an aspect of the present invention, it is possible to incrementally train a classifier in VFS and perform classification in various variable spaces that are learned directly or indirectly by the classifier trained through incremental learning.

Meanwhile, effects of the present invention are not limited to those described above, and other effects that have not been described will be clearly understood by those of ordinary skill in the art from the above description.

Implementations described herein may be embodied as, for example, a method, a process, a device, a software program, a data stream, or a signal. Even when discussed in the context of a single form of implementation (e.g., only discussed as a method), the discussed features may also be realized in another form (e.g., a device or a program). The device may be implemented as a suitable form, such as hardware, software, firmware, or the like. The method may be realized in a device, such as a processor, generally referred to as a processing device including, for example, a computer, a microprocessor, an integrated circuit, a programmable logic device, or the like. The processor may also include a communication device, such as a computer, a cellular phone, a personal digital assistant (PDA), and other communication devices, that facilitates information communication between end users.

Although the present invention has been described above with reference to embodiments illustrated in the drawings, the embodiments are merely illustrative, and those of ordinary skill in the art should understand that various modifications and other equivalent embodiments can be made from the embodiments. Therefore, the technical scope of the present invention should be determined from the following claims.

What is claimed is:

1. A classifier training device for incrementally training a classifier in varying feature spaces (VFS), the classifier training device comprising:
a memory configured to store at least one instruction; and
a processor configured to execute the at least one instruction stored in the memory,
wherein, when input data is received, the processor updates at least one of existing base models constituting an ensemble model on the basis of the input data, generates at least one new base model on the basis of the input data, and adds the at least one new base model to the ensemble model.

2. The classifier training device of claim 1, wherein the ensemble model is an averaged n-dependence estimator (AnDE).

3. The classifier training device of claim 1, wherein the processor selects at least one of the existing base models as a target base model on the basis of the input data and updates the target base model on the basis of the input data.

4. The classifier training device of claim 3, wherein the processor selects, as the target base model, a base model of which all variables corresponding to parent nodes are included in a variable space of the input data.

5. The classifier training device of claim 4, wherein the processor updates a possibility table corresponding to variables included in the variable space of the input data among all variables corresponding to the parent nodes and child nodes of the target base model.

6. The classifier training device of claim 1, wherein the processor generates a candidate variable set on the basis of the input data and generates the new base model on the basis of variables included in the candidate variable set.

7. The classifier training device of claim 6, wherein the processor identifies variables that are not included in a variable space of the ensemble model among variables included in a variable space of the input data and includes the identified variables in the candidate variable set.

8. The classifier training device of claim 6, wherein the processor calculates distance values from each of variables included in a variable space of the input data to each of variables included in a variable space of the ensemble model, selects n of the variables included in the variable space of the input data on the basis of the calculated distance values, and includes the n selected variables in the candidate variable set.

9. The classifier training device of claim 6, wherein the processor calculates frequencies of each of variables included in a variable space of the input data being used as a parent node in a variable space of the ensemble model, identifies n variables in increasing order of the calculated frequencies, and includes the n identified variables in the candidate variable set.

10. The classifier training device of claim 7, wherein the processor generates, as the new base model, a base model that has at least one of the variables included in the candidate variable set as a parent node and has the variables in the variable space of the input data other than the variable selected as the parent node as child nodes.

11. The classifier training device of claim 1, wherein the processor calculates evaluation indices for each of base models constituting the ensemble model, and
the evaluation indices are used in a pruning process of the base models constituting the ensemble model.

12. The classifier training device of claim 11, wherein the processor performs a process of calculating an accumulated classification accuracy index, calculating an expected evaluation index, and adding the accumulated classification accuracy index and the expected evaluation index to which a preset weight is applied, for a base model to calculate an evaluation index for the base model.

13. The classifier training device of claim 12, wherein the processor performs a process of classifying instances included in the input data and storing classification results for each of the base models constituting the ensemble model every time input data is received, and performs a process of analyzing cumulatively stored classification results for the base model to calculate an accumulated classification accuracy index for the base model.

14. The classifier training device of claim 13, wherein the processor performs a process of calculating uniqueness indices of each of variables included in a variable space and calculating an average of the calculated uniqueness indices for the base model to calculate an expected evaluation index for the base model.

15. The classifier training device of claim 14, wherein the processor calculates distance values from each of the variables included in the variable space to each of the variables included in the variable space other than the variable, calculates a sum of the calculated distance values, and divides the calculated sum by (a total number of variables included in the variable space-1) to calculate a uniqueness index of any variable included in any variable space.

16. The classifier training device of claim 1, wherein the processor calculates information about a parent node of each base model, a generation method for the parent node, a number of all instances included in all input data used for training, and an elapsed time after generation.

17. A classifier training method for incrementally training a classifier in varying feature spaces (VFS) which is performed by a computing device including a processor, the classifier training method comprising:
when input data is received, updating at least one of existing base models constituting an ensemble model on the basis of the input data;
generating at least one new base model on the basis of the input data; and
adding the at least one new base model to the ensemble model.

18. The classifier training method of claim 17, wherein the ensemble model is an averaged n-dependence estimator (AnDE).

19. The classifier training method of claim 17, wherein the updating of the at least one existing base model comprises selecting at least one of the existing base models as a target base model on the basis of the input data and updating the target base model on the basis of the input data.

20. The classifier training method of claim 19, wherein the updating of the at least one existing base model comprises selecting, as the target base model, a base model of which all variables corresponding to parent nodes are included in a variable space of the input data.
